(19) United States
(12) Patent Application Publication
(10) Pub. No.: US 2010/0313616 A1
(43) Pub. Date: Dec. 16, 2010

(54) COMBINATION LOCK CYLINDER

(75) Inventor: Miko Lee, Hsinchuang City (TW)

Correspondence Address: RABIN & Berdo, PC, 1101 14TH STREET, NW, SUITE 500, WASHINGTON, DC, 20005, US

(73) Assignee: ABA UFO INTERNATONAL CORP., Taipei Hsein (TW)

(21) Appl. No.: 12/481,803

(22) Filed: Jun. 10, 2009

(51) Int. Cl. E05B 37/02

(52) U.S. Cl. 70/332

(57) ABSTRACT

A combination lock cylinder has a shell and multiple external wheels. Multiple resilient ribs are attached respectively in mounting recesses of the shell. Each resilient rib corresponds to one mounting recess and has a central protrusion. Each external wheel has multiple elongated ribs formed transversely out from the outside wall. With the resilient force of the resilient ribs and the interaction between the elongated ribs and the central protrusions, the external wheels are positioned at predetermined positions automatically.

### BACKGROUND OF THE INVENTION

1. Field of the Invention

The present invention relates to a combination lock cylinder, especially to a combination lock cylinder mounted in a lock to actuate locking or unlocking.

2. Description of the Prior Arts

With reference to FIG. 8, a conventional combination lock cylinder (400) comprises a shell (40), an internal lock actuator (50), multiple external wheels (60) and a limiting element (70). The internal lock actuator (50) is mounted through the external wheels (60). The user turns the external wheels (60) to interact with the internal lock actuator (50) so that the conventional combination lock cylinder (400) performs locking or locking.

The limiting element (70) with multiple resilient probes (71) is mounted in the shell (40) and is adjacent to the external wheels (60). Each resilient probe (71) corresponds to and selectively holds a notch (61) of one external wheel (60). Indicating patterns are formed between adjacent notches (61) as marks to show whether the external wheels (60) are turned to a specific position to lock or unlock. When the external wheels (60) are turned, the resilient probes (71) selectively hold the corresponding notches (61) to reveal a desired pattern on the external wheels (60).

However, the conventional combination lock cylinder (400) has following disadvantages.

1. Because the resilient probes (71) keep contact with the external wheels (60), the friction between the resilient probes (71) and the external wheels (60) also hold the external wheels (60) at any angle without specifically reveal a certain pattern. Therefore, the user is not easy to determine whether the external wheels (60) are properly positioned to lock or unlock.

2. The outside walls of the external wheels (60) are almost flat so that the external wheels (60) are not easy to turn. Even though the external wheels (60) have the notches (61), the notches (61) are also not easy for acting force to turn the external wheels (60).

3. When mounting the limiting element (70) and the external wheels (60), each resilient probe (71) needs to be concisely correspond to the corresponding external wheel (60) to consume much assembling time.

To overcome the shortcomings, the present invention provides a combination lock cylinder to mitigate or obviate the aforementioned problems.

### SUMMARY OF THE INVENTION

The main objective of the present invention is to provide a combination lock cylinder with external wheels that is rotated to specific positions and with simplified manufacturing procedure. The combination lock cylinder has a shell and multiple external wheels. Multiple resilient ribs are attached respectively in mounting recesses of the shell. Each resilient rib corresponds to one mounting recess and has a central protrusion. Each external wheel has multiple elongated ribs formed transversely out from the outside wall. With the resilient force of the resilient ribs and the interaction between the elongated ribs and the central protrusions, the external wheels are positioned at predetermined positions automatically.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a lock with a combination lock cylinder in accordance with the present invention;

FIG. 2 is an exploded perspective view of the lock in FIG. 1;

FIG. 3 is another exploded perspective view of the lock in FIG. 1;

FIG. 4 is a partially exploded perspective view of the combination lock cylinder in FIG. 1;

FIG. 5 is an end view in partial section of the combination lock cylinder in FIG. 1;

FIG. 6 is an operational end view in partial section of the combination lock cylinder in FIG. 1, showing turning the external wheel;

FIG. 7 is an end view in partial section of another embodiment of the combination lock cylinder in accordance with the present invention; and

FIG. 8 is an exploded perspective view of a lock with a conventional combination lock cylinder in accordance with the prior art.

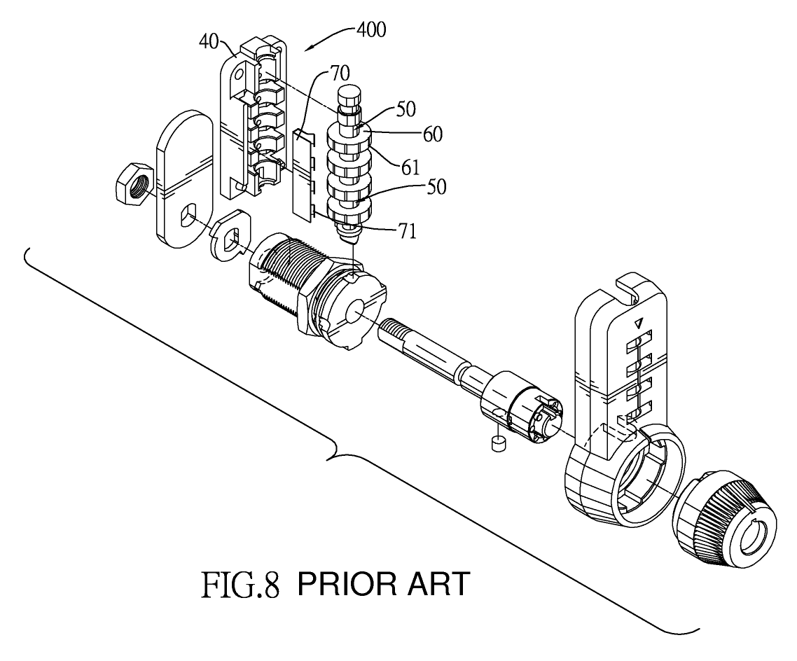

### DETAILED DESCRIPTION OF THE PREFERRED EMBODIMENTS

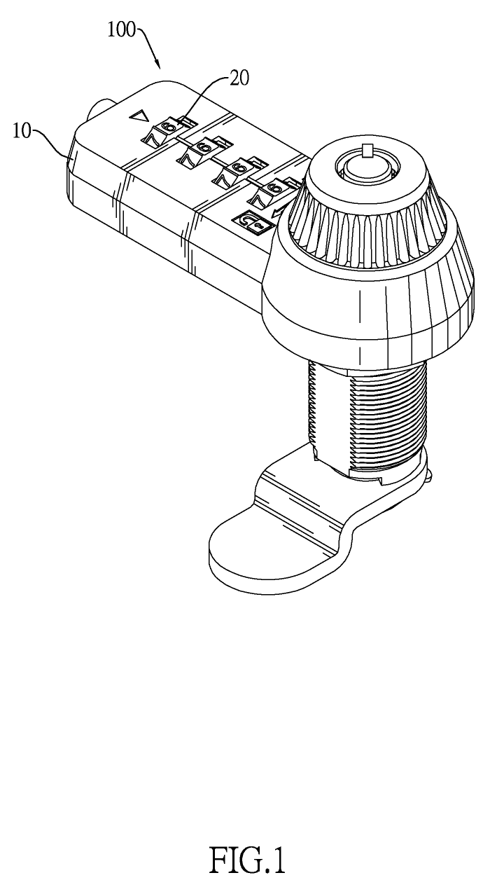

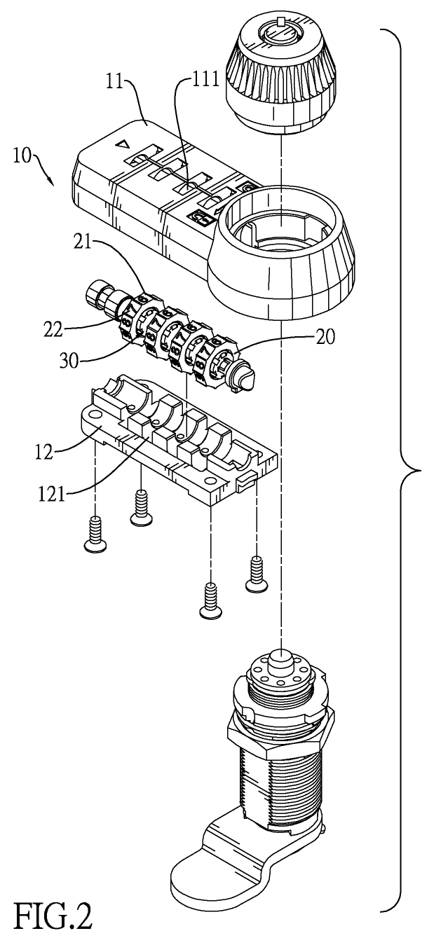

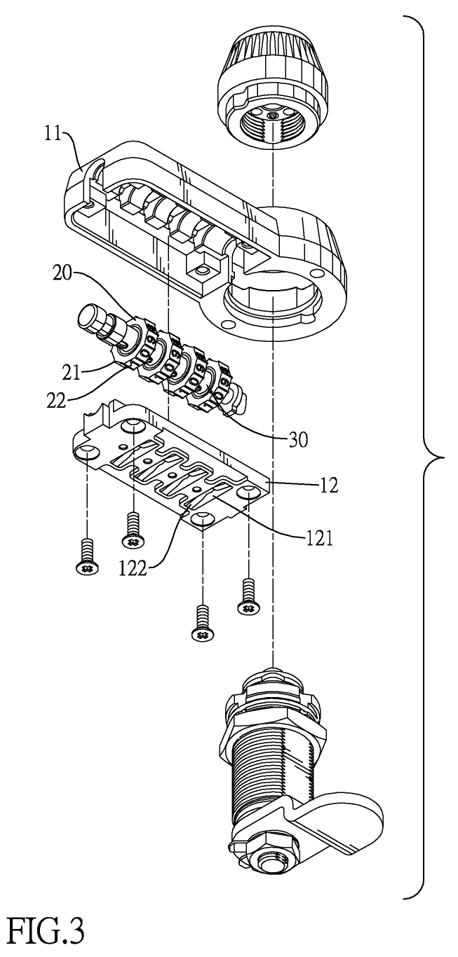

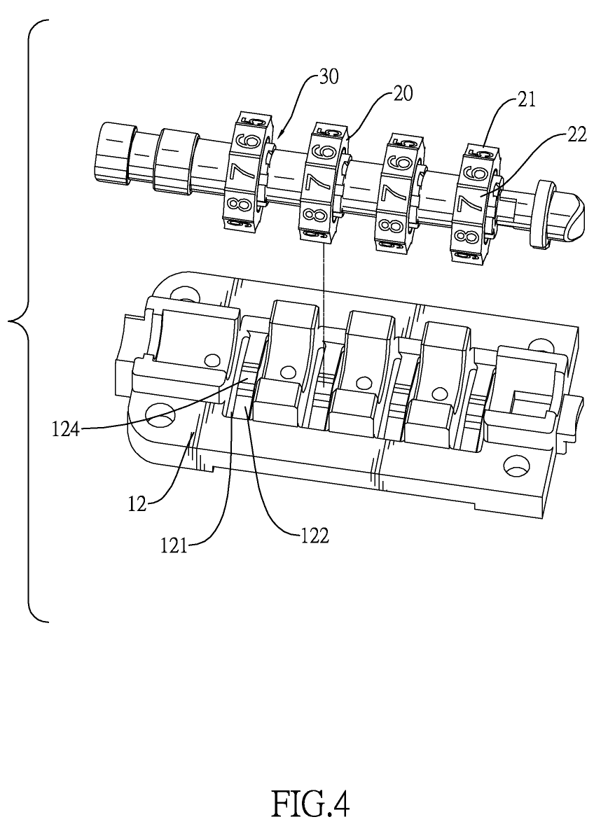

With reference to FIGS. 1 and 2, a combination lock cylinder in accordance with the present invention is mounted in a lock and has a shell (10), multiple external wheels (20) and an internal lock actuator (30). With reference to FIGS. 2 to 4, the shell (10) comprises a top casing (11) and a bottom casing (12) attached to each other. The top casing (11) has multiple through holes (111). The bottom casing (12) has multiple mounting recesses (121) and multiple resilient ribs (122). The mounting recesses (121) are formed in a top surface of the bottom casing (12). Each mounting recess (121) aligns with a corresponding through hole (111). Each resilient rib (122) is attached to a bottom of a corresponding mounting recess (121) and has two ends (123) and a central protrusion (124).

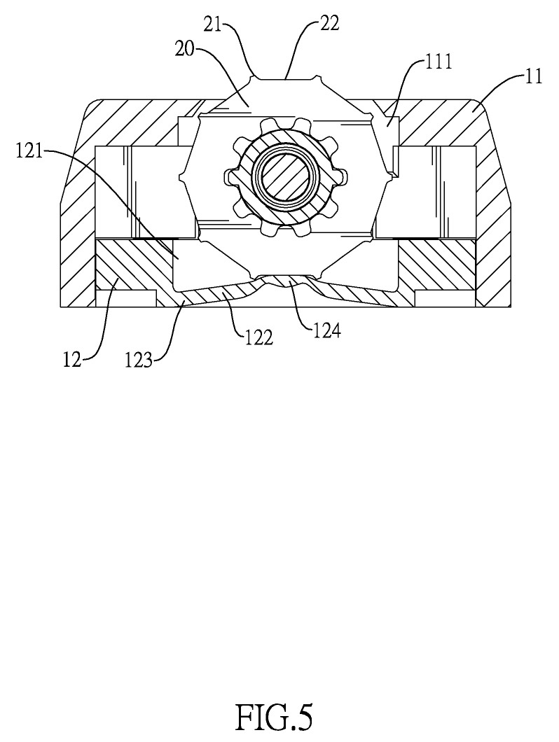

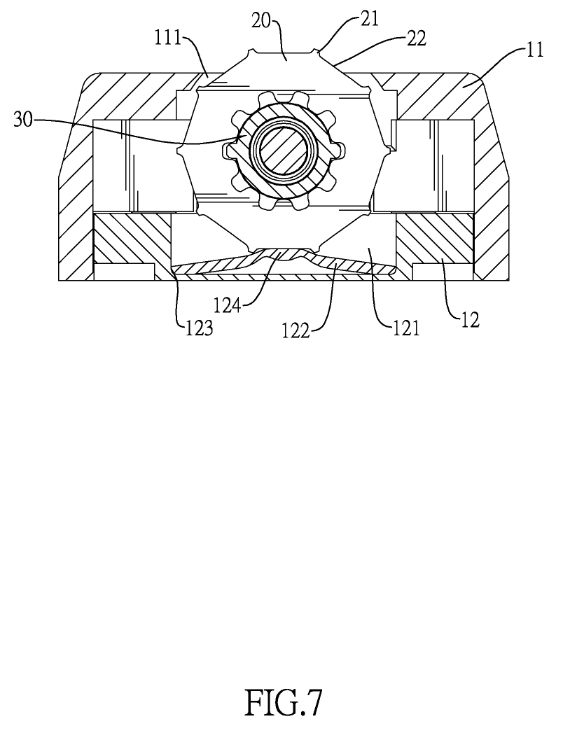

With reference to FIG. 5, in a preferred embodiment, the ends (123) of each resilient rib (122) are formed on sidewalls of the corresponding mounting recess (121). With reference to FIG. 7, in another preferred embodiment, each resilient rib (122) is plugged in the corresponding mounting recess (121) and the ends (123) of each resilient rib (122) abut sidewalls.

With reference to FIGS. 2 to 4, the external wheels (20) are mounted in the shell (10). Each external wheel (20) protrudes through a corresponding through hole (111) of the top casing (11), is mounted in a corresponding mounting recess (121) of the bottom casing (12) and abuts the central protrusion (124) of a corresponding resilient rib (122). Each external wheel (20) has multiple elongated protrusions (21) and multiple pattern sections (22). The elongated protrusions (21) protrudes transversely out from an outside wall of the external wheel (20). Each pattern section (22) is formed between adjacent elongated protrusions (21) and has pattern thereon (e.g. numbers, characters) to show specific position.

The internal lock actuator (30) is mounted in the shell (10) and is mounted through the external wheels (20) to interact with the external wheels (20) to perform locking and unlocking. The internal lock actuator (30) may have multiple internal wheels and a central rod. Detailed operation and structure of the internal lock actuator (30) is well known in the art so no detailed discussion is disclosed.

With further reference to FIG. 5, the external wheels (20) are rotated. When one pattern section (22) of each external wheel (20) abuts the central protrusion (124) of the corresponding resilient rib (122), the central protrusion (124) is clamped between two adjacent elongated protrusions (21) to securely position the external wheels (20). If the user wants to rotate the external wheels (20) while the external wheels (20) is securely positioned, the user needs to act more force to resist the resilient force of the resilient ribs (122).

The combination lock cylinder (100) as described has numerous advantages as follow.

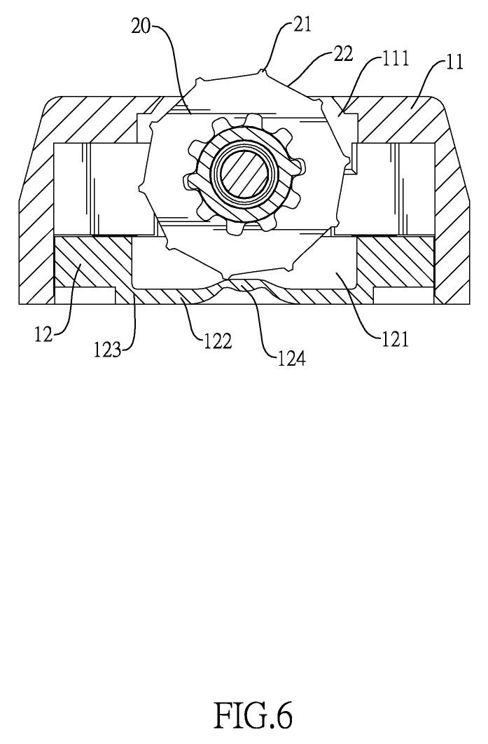

1. With reference to FIG. 6, the central protrusion (124) does not abut a pattern section (22). The central protrusion (124) must abut one elongated protrusion (21) since the elongated protrusions (21) protrude out from the outside wall of the external wheels (20). Then the elongated protrusion (21) compresses the central protrusion (124). Because of the resilient force reacting by the central protrusion (124), the external wheel (20) is non-stable to stay at such position. When the external wheel (20) are released, the resilient force from the central protrusion (124) forces the external wheel (20) to rotate until one pattern section (22) abuts the central protrusion (124) again. Therefore, the external wheels (20) are positioned to the predetermined positions.

2. With the elongated protrusions (21), the user act force on the elongated protrusions (21) to easily and precisely rotate the external wheels (20).

3. When the resilient ribs (122) are formed with the bottom casing (12) as shown in FIGS. 1 to 6, no assembling procedure is required. When the resilient ribs (122) are plugged in to the mounting recesses (121) as shown in FIG. 7, no precise aiming procedure is required since the resilient ribs (122) are separated and one resilient rib (122) corresponds to one mounting recesses (121). Therefore, the manufacturing procedure is simplified whether which embodiment of the present invention.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A combination lock cylinder comprising:
a shell having
a top casing having multiple through holes; and
a bottom casing attached to the top casing and having
multiple mounting recesses formed in a top surface of the bottom casing, and each mounting recess aligning with a corresponding through hole; and
multiple resilient ribs, each resilient rib attached to a bottom of a corresponding mounting recess and having two ends and a central protrusion;
multiple external wheels mounted in the shell, and each external wheel protruding through a corresponding through hole of the top casing, mounted in a corresponding mounting recess of the bottom casing, abutting the central protrusion of a corresponding resilient rib and having
multiple elongated protrusions protruding transversely out from an outside wall of the external wheel; and
multiple pattern sections, each pattern section formed between two adjacent elongated protrusions; and
an internal lock actuator mounted in the shell and mounted through the external wheels to interact with the external wheels to perform locking and unlocking.

2. The combination lock cylinder as claimed in claim 1, wherein the ends of each resilient rib are formed on sidewalls of the corresponding mounting recess.

3. The combination lock cylinder as claimed in claim 1, wherein each resilient rib is plugged in the corresponding mounting recess and the ends of each resilient rib abut sidewalls of the corresponding mounting recess.
